(19) United States
(12) Patent Application Publication
(10) Pub. No.: US 2004/0064763 A1
(43) Pub. Date: Apr. 1, 2004

(54) Apparatus and method for a trace system on a chip having multiple processing units

(76) Inventor: Gary L. Swoboda, Sugar Land, TX (US)

Correspondence Address: TEXAS INSTRUMENTS INCORPORATED, P O BOX 655474, M/S 3999, DALLAS, TX, 75265

(21) Appl. No.: 10/256,373

(22) Filed: Sep. 27, 2002

(51) Int. Cl. G06F 11/34

(52) U.S. Cl. 714/45

(57) ABSTRACT

In a semiconductor chip having a plurality of processing unit fabricated thereon, each of the processing units is provided switches having input terminals coupled to selected nodes of the processing unit. A debug port is provided for all of the processing units. The output terminals of a switch in each processing unit is to an output terminal of the debug port. The trace signals applied to the output terminals of the debug port are selectable thereby permitting any combination of states determined by the processing units to be applied to the output terminals. The output terminals of the debug port can have any combination of trace signals, trace clock signals, a high impedance states, and other functions applied thereto.

### BACKGROUND OF THE INVENTION

1. Field of the Invention

This invention relates generally to the testing of digital signal processing units and, more particularly, to the extraction of trace stream signals from chips having multiple processing cores fabricated thereon.

2. Background of the Invention

As microprocessors and digital signal processors have become increasingly complex, advanced techniques have been developed to test these devices. In particular, logic apparatus has been added so that signals at selected points in the processing circuit can be acquired and can be coupled to a debug port. A debug port is terminal accessible to external apparatus that permits the microprocessor or digital signal processor to exchange test and diagnostic signals with apparatus dedicated to generating and to analyzing test signals.

Referring to FIG. 1, a generalized data processing unit 10 along with apparatus to extract trace stream signals is shown. The processing unit 10 exchanges input/output signals with external apparatus. The signals received by the processing unit from the external apparatus are processed by components (not shown) of the processing unit and the processed signals are transmitted to external apparatus. To obtain the trace stream signals, switches 161-16N are fabricated on the chip along with the normal processing unit components. The input signals to the switches are conductors coupled to selected components of the processing unit 10. The components of the processing unit to which the input terminals are coupled provide the signals that have been selected to be monitored. In response to control signals, a particular set of signals is selected by the switches and applied to the debug port 19. The debug port typically includes interface apparatus the permits the trace stream (or debug) signals.

In general, the input/output signals are data signals, programming signals and control signals from user controlled apparatus and the results of the signal processing are applied to the appropriate receiving unit. As will be clear to those skilled in the art, dedicated apparatus can be used to apply predetermined signals to selected components of the data processing unit. In this manner, the operation of the selected and related components can be monitored more precisely. In the present invention, the generation and manipulation of trace signal streams is emphasized. A trace signal stream is sequence of signals monitored continuously during the operation of the data processing unit. For example, the signals on a selected bus may be monitored to identify the exchange of information between components that results from the execution of a given program. Knowing the implementation of the data processing system and the applied signals, the monitored signals can be analyzed against the expected signals for a predetermined data processing unit activity. While these test and diagnostic signals are clearly valuable in debugging the hardware implementing the data processing unit, these signals can also be used in debugging software procedures.

More recently, the ever-increasing need for power has lead to fabrication of semiconductor chips with more than one processing unit or core on the chip. The multiple cores can have the same architecture or can have different architectures. Each core can be provided with a dedicated debug port. However a dedicated debug port with each core can provide a difficult problem in coupling the debug port to the testing apparatus. A switch would be necessary to couple a selected debug port to the test apparatus.

A need has therefore been felt for apparatus and method having the feature of providing a trace stream for multiple processors on the same or different chips. It would be yet another feature of the apparatus and method to be able to allocate selectively the debug port output terminals to portions of a plurality of trace signal streams as needed. It would be yet another feature of the apparatus and method to provide a plurality of trace signal streams that can be transmitted at different rates through the debug port output terminals. It would be still a further feature of the present invention to provide a plurality of trace streams from processing units that can be at different rates. It would be a still further feature of the present invention to provide that a trace signal, a trace clock signal or a high impedance state can be present at the output terminals of the debug port.

### SUMMARY OF THE INVENTION

The aforementioned and other features are accomplished, according to the present invention, by providing with each of a plurality of processing units with a switch unit capable of selecting portions of a trace stream of each processor for application to the debug port. The input terminals of each of the switches are coupled to components in each or the processors providing signals useful in test and diagnostic procedures. The output signals of each switch of the processing units can be selectively applied to an associated output pin of the debug port. By application of appropriate control signals to the switches, selected trace signals from any combination of processing units can be applied to the trace port output terminals. In addition, any combination of trace signals, trace clock signals, a high impedance states or another functions can be selectively applied to the output terminals of the debug unit.

Other features and advantages of present invention will be more clearly understood upon reading of the following description and the accompanying drawings and the claims.

### BRIEF DESCRIPTION OF THE DRAWINGS

FIG. 1 is a generalized block diagram of a data processing unit along with test and diagnostic apparatus according to the prior art.

FIG. 2 is schematic diagram of the transfer of trace stream signals from a plurality of processing units to a debug port according to the present invention.

FIG. 3A and FIG. 3B illustrate possible trace signal streams possible from the multiple processing units according to the present invention.

### DETAILED DESCRIPTION OF THE FIGURES

1. Detailed Description of the Figures

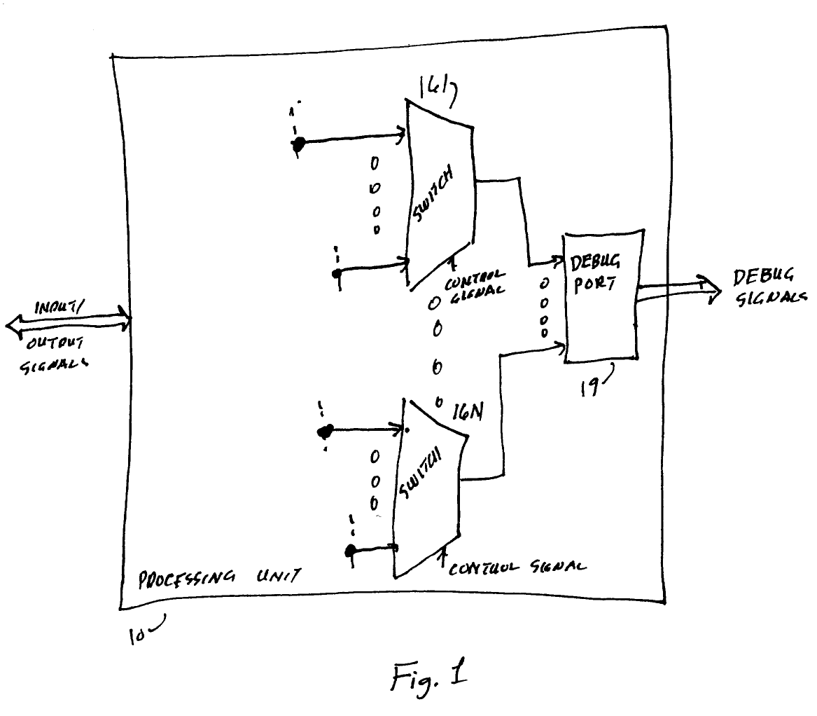

FIG. 1 has been described with respect to the related art.

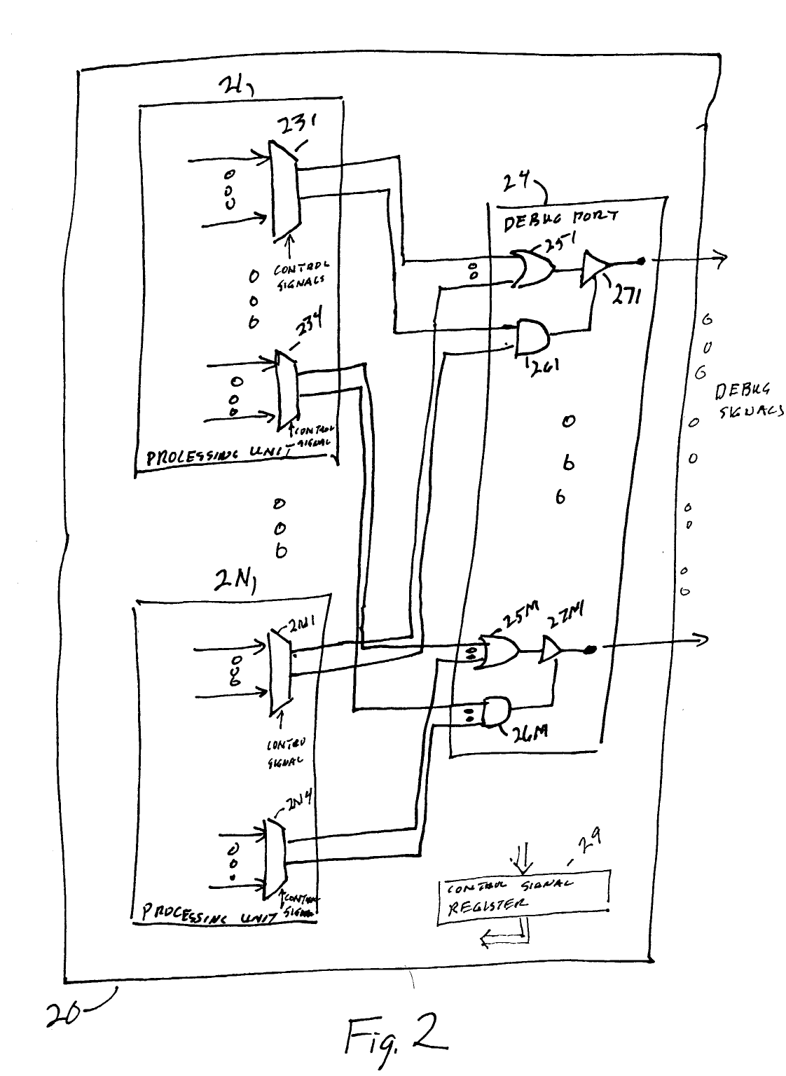

Referring to FIG. 2, a schematic diagram of the distribution of trace stream signal from a plurality of processing unit to a debug port is shown. A chip 20 has fabricated thereon plurality of processing units, 211-21N. Each processing unit 211-21N, in addition to the components used in processing applied signals, includes a plurality of switches 231-23M. The input terminals of each switch are coupled to predetermined components of the associated processing unit. The signals from the coupled component provide the test and diagnostic signals that can be included in the trace signal stream. The switch to which the predetermined components are coupled selects, as a result of control signals, the component that provides the test and diagnostic signal to the trace stream. When a component is selected to provide signals for the trace signal stream, the signals from the selected component are applied to one output terminal of the switch to which the component is coupled. The one output terminal of each switch 231 of each processing unit 21-2N is coupled to an input terminal of logic OR gate 251 of debug port 24. The second output terminal of the switch 231 of each processing unit is coupled to an input terminal of logic AND gate 261. The output terminal of logic OR gate 251 is coupled to an input terminal of amplifier 271, while the output terminal of logic AND gate 261 is coupled to a control terminal of amplifier 271. The output terminal of amplifier 271 is one pin of the debug port 24. The remaining switches of the processing units are coupled in a similar fashion to components of the debug port 24. For example, the first terminal of amplifier 23M for each processing unit is coupled to an input terminal of logic OR gate 25M and the second output terminal of switch 23M is coupled to an input terminal of logic AND gate 26M. The output terminal of the logic OR gate 25M is coupled to an input terminal of amplifier 27M, while an output terminal of logic AND gate 26M is coupled to a control terminal of amplifier 27M. The output terminal of amplifier 27M is the Mth pin of the debug port. The control signals that control the positions of switches 231 through 2N4 are generated from a control signal register 29. The contents of the control signal register 29 can be entered through input/output terminal of one of the processors 21 through 2N or can be directly accessible to the testing apparatus. In an alternative embodiment, each process 21-2N has its own control signal register.

2. Operation of the Preferred Embodiment

The operation of the present invention can be understood as follows. Each processor has a number of functions that are selectable to the debug port pins. These functions include trace data, trace clock signals, high impedance, and other functions. Control signals determine which switch input terminal, i.e., the signals from which component will be applied to output terminal one. If no signals are selected, then a signal is applied to switch output terminal two. Because the terminal one signals are applied to a logic OR gate, the logic OR gate applies the signals to the output amplifier and hence to the debug port output pin. The second output terminal of the switches provides a high impedance signal. When all the switches applying signals to a logic AND gate have the loge ONE state, a logic ONE state will be applied to the output terminal of the logic AND gate and applied to the control terminal of the amplifier. The application of a logic ONE state to the control terminal of the amplifier results in an high impedance (HI-z) state being seen by the operator. In the preferred embodiment, a high impedance state is imposed on any debug port output terminal that does not have a signal applied thereto.

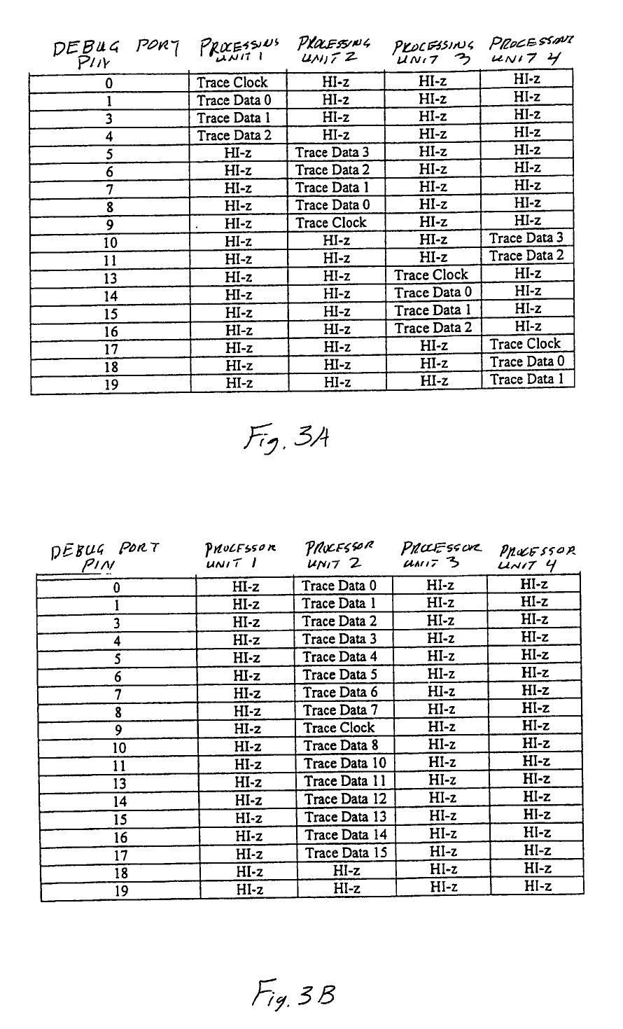

Referring to FIG. 3A and FIG. 3B, the flexibility of the foregoing test and diagnostic configuration is shown. In the Tables shown in FIG. 3A and FIG. 3B, the chip is assumed to have four processing units fabricated thereon and the debug port is assumed to have 20 pins (for 20 output signals). In FIG. 3A, all of the debug port pins have trace or trace clock signals applied thereto. Note that the trace signal assignment of the pins is relatively flexible. In FIG. 3B, rather than a few signals from each processing unit being applied to the debug port output pins, in FIG. 3B, all of the output signals are derived from one processing unit. Therefore, the present invention provides flexibility in the test and diagnostic procedures of one or more processing units in the sense that when one processing unit requires more bandwidth for testing, that increased bandwidth can be accommodated by the present invention.

While the foregoing description assumes that the processing units have the same number of debug unit output pins as the processing unit has cores, it will be clear that this restriction is not necessary. In fact, in the preferred embodiment the processing units can have different architectures. What is important is the relationship between the possible trace signals of each processing unit and the debug output pins be known so that appropriate controls signals can be applied to provide the required composition of the trace signal streams. Similarly, the test and diagnostic configuration are described as being on a single chip. It will be clear that the present invention can provide advantageous functionality when one or more of the processing units and/or the debug port are on separate semiconductor substrates.

While the invention has been described with respect to the embodiments set forth above, the invention is not necessarily limited to these embodiments. Accordingly, other embodiments, variations, and improvements not described herein are not necessarily excluded from the scope of the invention, the scope of the invention being defined by the following claims.

What is claimed is:

1. A system for generating trace signal streams, the system comprising:
a plurality of processing units, each processing unit including a plurality of switches, each switch having input terminals coupled to nodes of the processing unit, the output state of the switch determined by control signals applied to the switch; and
a debug port, the debug port having a first plurality of output terminals, wherein each output terminal of is coupled to at least one switch of each processing unit, the control signals to the switches determining which switch provides the output state for the debug port output terminal.

2. The system as recited in claim 1 wherein the state of each output terminal of the debug port is selected from the group consisting of trace signals, trace clock signals, and a high impedance states.

3. The system as recited in claim 1 wherein the plurality of processors and the debug port are fabricated on a signal semiconductor chip.

4. The system as recited in claim 1 wherein when no signal is applied to an output terminal of the debug port, the debug port output terminal is in a high impedance state.

5. The system as recited in claim 1 wherein the debug port includes a logic OR gate having an output terminal from a switch in each of the processing units coupled to input terminals of the logic OR gate, an output terminal of the logic OR gate coupled to an output terminal of the debug port.

6. The system as recited in claim 1 wherein the debug port includes:
an amplifier coupled to an output terminal of the debug port.
a logic AND gate coupled to a control terminal of the amplifier, each input terminal of the logic AND gate coupled to an output terminal of a switch of a different processing unit.

7. The system as recited in claim 5 the debug port further includes an amplifier coupled between the output terminal of the logic OR gate and the output terminal of the debug port.

8. The system as recited in claim 1 wherein at least two of the processing units are operating at different clock rates.

9. The method for providing trace stream for a plurality of processing units, the method comprising:
in each processing unit, providing a plurality of switches, the input terminals of each switch coupled to predetermined nodes of the processing unit, the output signals of the switches determined by control signals;
coupling switch output terminals from a switch in each of a plurality of processing units to an output terminal of a debug port; and
applying control signals to the switches, the control signals determining the configuration of signals from the processing units applied to the output terminals of the debug port.

10. The method as recited in claim 8 wherein the states of the output terminals of the debug unit can be any combination of trace signals, trace clock signals, high impedance states, and other functions.

11. The method as recited in claim 9 wherein states of the output terminals of the debug unit can be signals from a combination of processing units.

12. The method as recited in claim 8 wherein the absence of signals applied to and output terminal of the debug unit results in a high impedance state for the output terminal.

13. The method as recited in claim 8 wherein at least two processing units are operating at different clock rates.

14. A trace generating system for generating trace streams for a plurality of processing units, the system comprising:
in each processing unit, a plurality of switches, each switch having a plurality of input terminals, each input terminal being coupled to a predetermined node of the processing unit, the output signal of each switch determined by control signals applied to the switch; and
a debug port having a plurality of output terminals, each output terminal coupled to an output terminal of a switch in a second plurality of the processing units.

15. The system as recited in claim 13 wherein the output states of each debug port output terminal is selected from the group consisting of trace signals, trace clock signals, high impedance states, and other functions.

16. The system as recited in claim 13 wherein any combination of output signals from the plurality of processing units can be applied to the debug port output terminals.

17. The system as recited in claim 13 further including a logic OR gate coupled to a debug port output terminal, wherein the output terminals from a switch in each of the second plurality of processing units is coupled to the logic OR gate.

18. The system as recited in claim 16 further including an amplifier coupled between a logic OR gate and the associated debug port output terminal.

19. The system as recited in claim 13 wherein at least two of the processing units are operating at different clock rates.
